(19) United States
(12) Patent Application Publication
(10) Pub. No.: US 2017/0020119 A1
(43) Pub. Date: Jan. 26, 2017

(54) Insect Attractant and Capture System

(71) Applicant: Mark Naden, New York, NY (US)

(72) Inventor: Mark Naden, New York, NY (US)

(21) Appl. No.: 15/193,439

(22) Filed: Jun. 27, 2016

Related U.S. Application Data
(60) Provisional application No. 62/185,566, filed on Jun. 27, 2015.

(51) Int. Cl. A01M 1/02; A01M 1/10

(52) U.S. Cl. CPC A01M 1/02; A01M 1/10

(57) ABSTRACT

An apparatus for capturing insects and allowing for their eventual release or cleaning of the apparatus is disclosed. The capture system allows for the safe and efficient capture of a variety of flying insects through the use of a natural attractant and a capture apparatus. The multi-part capture apparatus allows for easy cleaning, replenishment of the natural attractant, and release of the insects after capture. The multi-part capture apparatus also significantly reduces the ability of insect escape through the possible exit point.

### FIELD OF THE INVENTION

The present invention generally relates to insect capture devices. In particular, the present invention is directed to an insect attractant and capture system.

### BACKGROUND

Insects, such as flies, gnats, fruit flies, or any other insect that comes indoors, create a nuisance, and breed, have always been a difficult and annoying problem. Various methods of capturing and killing insects are known in the art and have been developed to reduce or eliminate the problem. Typically, these methods involve some sort of poison or insecticide to disable and/or kill the insect. Yet, the locations where these insects are often found are the same places where humans breathe and eat. Thus, there is a chance that some of these insecticides will find their way into the air and onto surfaces that will come in contact with humans. Many of the insecticides used to kill or disable insects are harmful to humans, as evidenced by the warnings against human contact, ingestion, or inhalation made by all of these dangerous products. In fact, physical contact with these products can lead to irritating and potentially harmful effects on humans, especially children.

Food is one of the chief attractants for insects indoors and thus the kitchen is a prime location for the use of typical insect mitigation products. Unfortunately the presence of food for human consumption also makes this one of the most dangerous places to use poisonous products as the insecticides may contaminate food, which may then be consumed by humans.

There are many devices available that purport to capture various insects. Chiefly these devices rely on an insect's propensity to fly upward when threatened. Thus, the devices locate the entrance (and consequently exit) point at a position that decreases the odds that the insect will escape.

These devices have several disadvantages: 1) a certain percentage of insects escape the device, 2) many are designed to be home-made, but few are adept at recreating the desired completed device, 3) the devices are unsuitable for most inhabited interior spaces due to unstable designs and low durability construction materials (often tape and plastic bottles), 4) insects dying within the devices creating a mess which that typically results in disposal of the entire device rather than cleaning and reusing the device, and 5) there is no sustainable means of disposal of the device once filled with insecticides and dead insects.

### SUMMARY OF THE DISCLOSURE

In an exemplary aspect there is described an insect capture apparatus comprising a bottom portion sized and configured to hold an insect attractant; an internal barrier resting on the bottom portion, the internal barrier having a detention portion; and a top portion coupled to the bottom portion and holding the internal barrier in between the top portion and the bottom portion, the top portion including an entry point, wherein the entry point includes and aperture extending therethrough with an exit of the aperture being below a bottom edge of the internal barrier.

In another exemplary aspect there is described an insect capture system comprising a container including a top portion having an entry point extending toward a center of the container; an internal barrier having a riser having an aperture and configured to cooperatively engage the entry point such that insects travel from the entry point through the aperture; and a bottom portion coupled to the internal barrier and the top portion, the bottom portion designed and configured to receive an insect attractant.

In yet another exemplary aspect there is described a method of capturing insects comprising preparing an insect attractant; luring the insects through an extended conically shaped aperture and into a capture device with the insect attractant; preventing the escape of the insects by routing the insects away from the conically shaped aperture; and trapping the insects in a region of the capture device that does not include direct access to the attractant.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is an isometric view of an insect attractant and capture system according to an embodiment of the present invention;

FIG. 2 is an exploded isometric view of the insect capture apparatus shown in FIG. 1;

FIG. 3 is an isometric view of an insect attractant and capture system according to another embodiment of the present invention; and

FIG. 4 is an exploded isometric view of the insect capture apparatus of FIG. 3.

### DESCRIPTION OF THE DISCLOSURE

An insect attractant and capture system of the present disclosure allows for the safe and efficient capture of a variety of flying insects through the use of a natural attractant and a capture apparatus. The multi-part capture apparatus allows for easy cleaning, replenishment of the natural attractant, and release of the insects after capture. The multi-part capture apparatus also significantly reduces the ability of insect escape through the possible exit point.

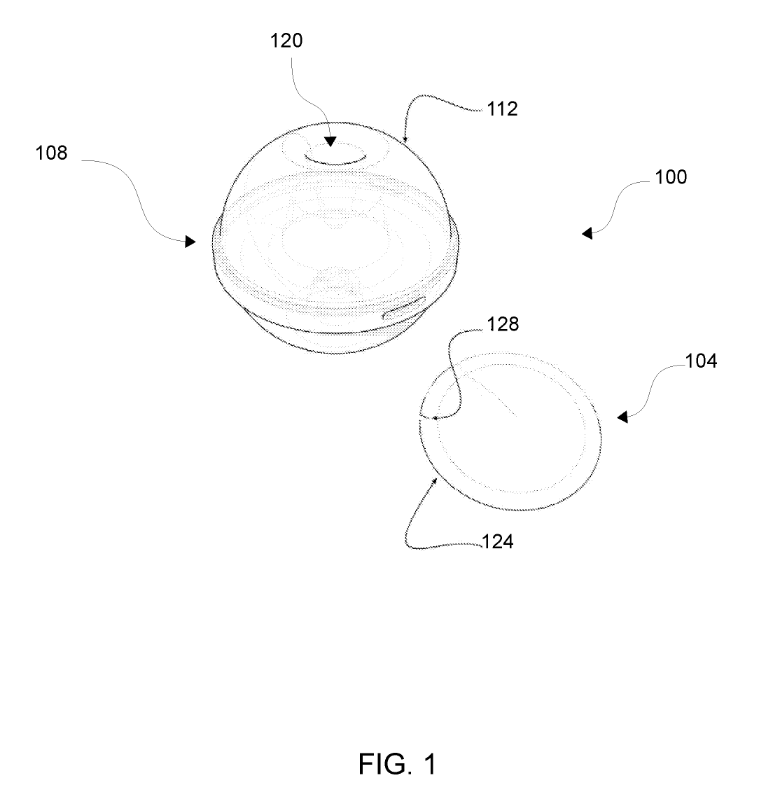

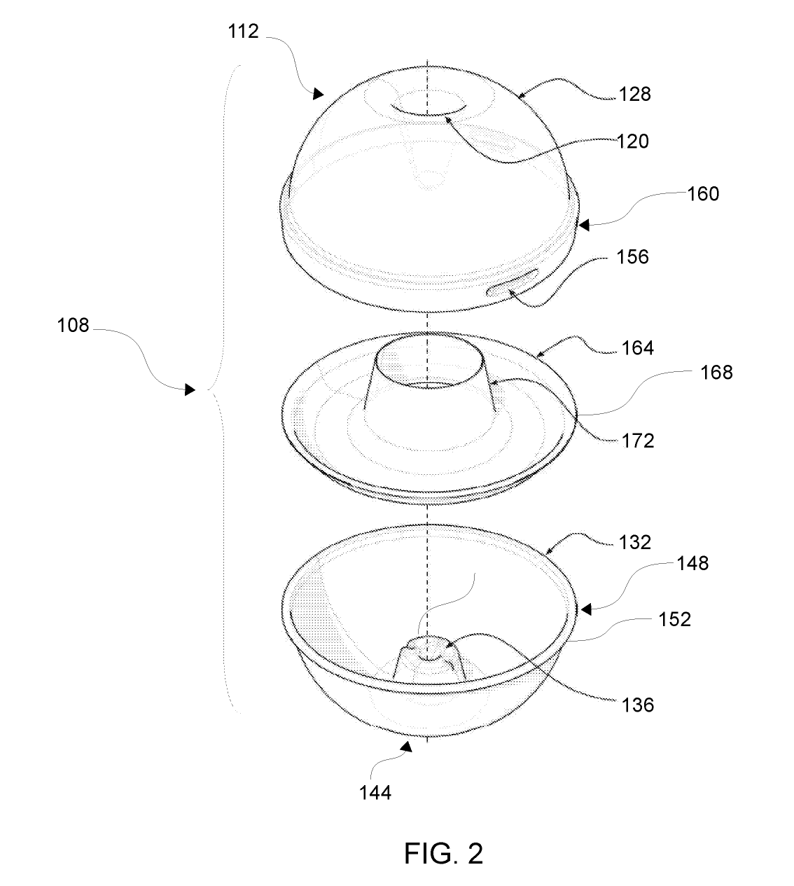

Turning now to a discussion of the figures where similar elements are labeled the same throughout, and specifically with reference to FIGS. 1 and 2, there is shown an insect attractant and capture system 100 of the present disclosure, which, at a high level, includes a natural insect attractant 104 that serves as bait for luring insects and an insect capture apparatus, such as insect capture apparatus 108 shown in FIG. 1, comprising a container 112, an internal barrier 116 (best seen in FIG. 2), and an entry point 120.

Insect attractant 104 can be a mixture of natural, non-harmful to humans, ingredients that are attractive to the intended insect. Insect attractant 104 may be liquid, powdered, premixed, gelled, hard, or a product of any other consistency and makeup. Insect attractant 104 may be pre-mixed or require the addition of water for activation before use. In an exemplary embodiment, insect attractant 104 is contained within a small sachet 124 that includes a notch 128 indicating a place for opening the sachet. In another exemplary embodiment, a user mixes a combination of naturally occurring ingredients, e.g., a banana, and an activation powder which is composed of ingredients designed to increase the attractant's effectiveness, prevent discoloration and molding of the naturally occurring ingredient(s), and to discourage/minimize egg laying by the insects. In another embodiment, the activation powder and naturally occurring ingredient can be premixed. Of course, other types of containers and sachets are available and could be within the scope of the present disclosure.

An exemplary embodiment of an insect capture apparatus 108 according to the present invention is shown in exploded view in FIG. 2. As mentioned above, insect capture apparatus 108 includes container 112, which has a top portion 128 and a bottom portion 132 that are configured to support and hold the insect attractant and to assist in the retained capture of insects. Top portion 128 and bottom portion 132 are removably coupled together, which assists in assembly/disassembly of insect capture apparatus 108. For example, top portion 128 and bottom portion 132 may have mating threads that allow the top portion and the bottom portion to be screwed together. Other means and methods of attaching bottom portion to top portion, such as a snap fit, press fit, or other fitting methods that allow for assembly and disassembly may also be used. Although not as preferred, insect capture apparatus 108 can also be designed and configured to be single use, and as such, top portion 128 and bottom portion 132 may be fused together after assembly, thereby hindering the removal of the insect attractant 104 and/or insects captured by system 100.

Bottom portion 132 may include a rise 136, which as shown in FIG. 2 is generally shaped as a frustum, the top of which may act as an indicator 140 of the amount of insect attractant 104 (or other liquid to mix with a dry or powdered attractant) to add to the bottom portion. Bottom portion 132 is typically sized and configured to hold insect attractant 104. Bottom portion 132 may also include a substantially flat shelf 144 that allows for stable resting of system 100 on a table or other surface. In another exemplary embodiment, bottom portion 132 may include or have the ability to accept a dish (not shown) for insect attractant 104. As mentioned above, bottom portion 132 may also include a portion of a coupling device 148 configured to attach the bottom portion to top portion 128. For example, and as shown in FIG. 2, a ridge 152 is disposed on the periphery of bottom portion 132 and is configured to engage with connecting tabs 156 disposed on top portion 128.

Top portion 128 is sized and configured to mate with bottom portion 132 and includes entry point 120 (discussed in more detail below) for insects to access insect attractant 104 found in the bottom portion. Top portion 128 also includes an outer rim 160 with the outer rim including the plurality of connecting tabs 156 around its internal periphery. When top portion 128 is engaged with bottom portion 132, connecting tabs 156 are slid around and eventually under ridge 152 of the bottom portion, thereby connecting the two portions.

In between top portion 128 and bottom portion 132 is at least one internal barrier 164. Internal barrier 164 is configured to rest on bottom portion 132 and to be held in place by the coupling of top portion 128 to bottom portion 132. In the exemplary embodiment shown in FIG. 2, internal barrier 164 includes a ledge 168 that rests on ridge 152 of bottom portion 132. Ledge 168 is configured to be held between ridge 152 of bottom portion 132 and the outer rim 160 of top portion. Internal barrier 164 includes a detention portion 172 that is configured such that insects may rise within container 112, but reduces the opportunity for the insects to find entry point 120 (so as to use it as an exit), thus dramatically increasing the odds that an insect will not escape. As shown in FIG. 2, detention portion 172 is generally a frustum having an aperture 176 that extends therethrough. The diameter of the frustum in detention portion 172 is such that insects, after coming through entry point 160 are allowed to fly upward; however, because the detention portion diameter is much larger than the entry point, the insects are trapped underneath top portion 128. The diameter of the frustum is generally not so big as to capture the insects in bottom portion 132 with insect attractant 104 as doing so would cause insects to drown or die in the insert attractant necessitating earlier replacement of the insect attractant. Instead, insects are generally contained between internal barrier 164 and top portion 128 until the top portion is separated from bottom portion 132 for cleaning or release of the insects.

Entry point 120 is positioned and configured so as to make it difficult for the insect to exit after passing through the entry point. In an exemplary embodiment, by configuring entry point 120 to extend from the periphery of top portion 128 to below the lower edge of the internal barrier 164 (edge that faces bottom portion 132), escape of insects is minimized.

In operation, after placing insect attractant 104 in bottom portion 132, internal barrier 164 is placed on top of the bottom portion and top portion 128 is secured to the bottom portion. Insects are attracted to insect attractant 104 and they traverse through entry point 120. After entering container 112, the insect attempts to leave by flying upward but travels through detention portion 172 and becomes trapped in the upper chamber. Once a sufficient number of insects have been captured, or the room is no longer plagued by the insects in question, the user can proceed a sufficient distance to release the insects from the in-door space. In an exemplary embodiment, insect attractant and capture system 100 may be composed of recyclable and/or biodegradable components such that the system could be safely disposed of.

An insect attractant and capture system, such as insect attractant and capture system 100 (or 200 as described below), of the present disclosure addresses the deficiencies of the prior art as it is natural and safe for use around food and people, conveniently readymade, can be made from all compostable products so that disposal has no environmental impact, and is a simple and tasteful object suitable for display in homes and offices.

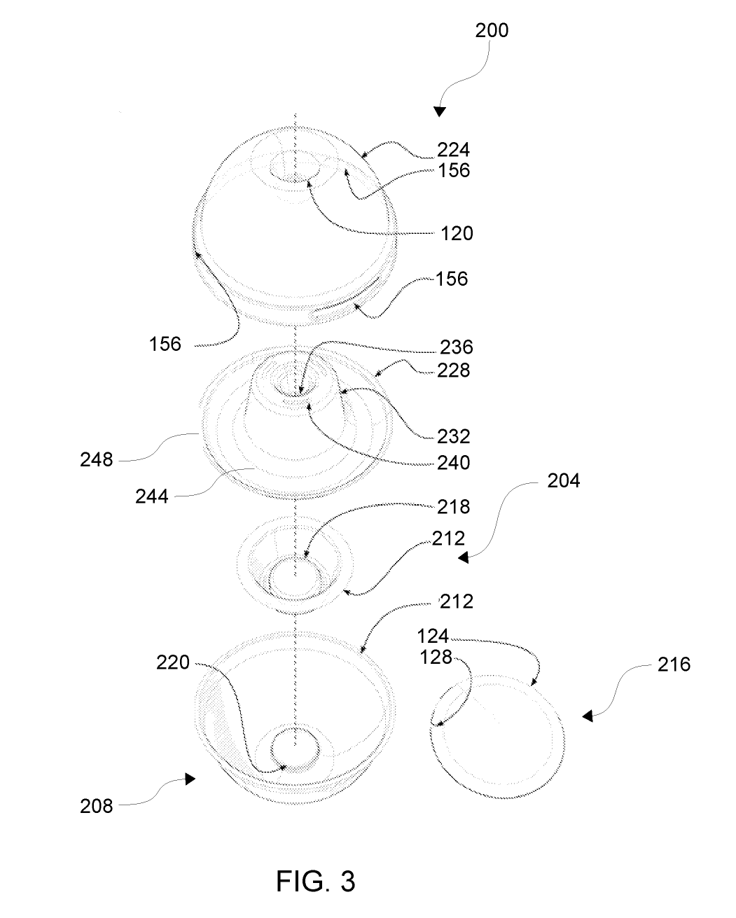

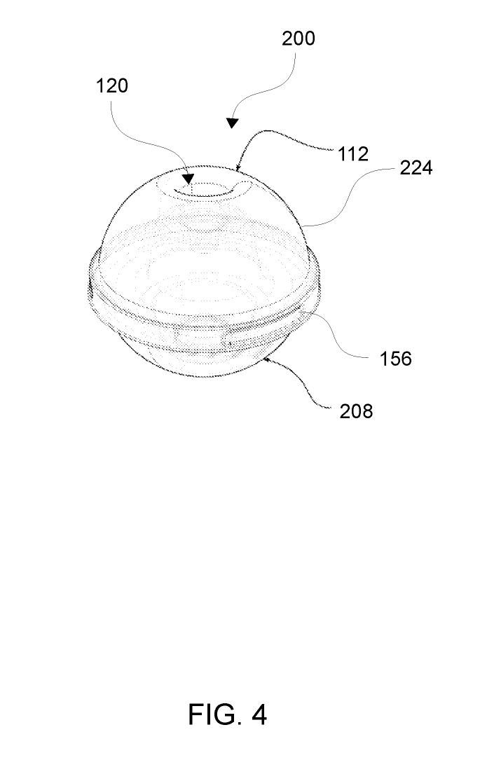

Turning now to another exemplary embodiment of an insect attractant and capture system, insect attractant and capture system 200 is shown in FIGS. 3 and 4. In this embodiment, insect attractant 204 is designed and configured to mate a bottom portion 208. For example, and as shown in FIG. 3, insect attractant 204 includes an attractant container 212 and a lid 216. The attractant container includes a bottom designed and configured to mate with bottom portion 208. In another exemplary embodiment, attractant container 212 and lid 216 can be combined into a single module that mates with bottom portion 208.

Bottom portion 208 is substantially similar to bottom portion 132, except that it includes a rise 220, which serves as an attachment point of attractant container 212. In an exemplary embodiment, attractant container 212 includes a mating connection 218 that allows for a snap fit with rise 220, thus securing the insect attractant in place. Alternatively, adhesives, mating connectors, or other techniques could be used to join rise 220 and attractant container.

Insect attractant and capture system 200 also includes a top portion 224 that is similar to top portion 128. Top portion 224 includes an entry point 120, designed, as shown, as a frustum. In this embodiment, entry point 120 is shorter relative to that shown in FIGS. 1 and 2. This shorter entry point is accommodated by the inclusion of internal barrier 228.

Internal barrier 228 provides a pathway to insect attractant 204 for insects and also prevents there escape from system 200. Internal barrier 228 includes a conically shaped riser 232 that includes an aperture 236 leading to insect attractant 204. Entry point 120 and aperture 236 cooperate to move insects from top portion 224 to the underside of internal barrier 228. Riser 232 also includes a plurality of slots 240, designed and configured to allow insects to move from the underside of internal barrier 228 to a region between top portion 224 and the internal barrier. This configuration allows system 200 to keep insects away from the insect attractant 204 after entering the system.

Riser 232 is surrounded by an insect retention region 244 that extends from the riser to an edge 248. Edge 244 mates with bottom portion 208 and serves to secure internal barrier 228 in place once top portion 224 and bottom portion 208 are joined together.

The systems described herein, e.g., 100 and 200, may preferably be constructed of a transparent or semi-opaque material which has the advantages of allowing a user to monitor the effectiveness of the system and concomitantly when to empty the device or replace the attractant. Additionally, the availability of light entering the system from multiple angles disorients the insects from distinguishing between the entry point 120 and other features of the system, thereby increasing the system's effectives.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An insect capture apparatus comprising:
a bottom portion sized and configured to hold an insect attractant;
an internal barrier resting on said bottom portion, said internal barrier having a detention portion; and
a top portion coupled to said bottom portion and holding said internal barrier in between said top portion and said bottom portion, said top portion including an entry point, wherein said entry point includes and aperture extending therethrough with an exit of said aperture being below a bottom edge of said internal barrier.

2. An insect capture apparatus of claim 1, wherein said top portion and said bottom portion are releasably coupled to each other.

3. An insect capture apparatus of claim 1, wherein said detention portion is defined by a conically area extending toward said top portion and an insect collecting region.

4. An insect capture apparatus of claim 1, wherein said entry point is shaped as a frustum.

5. An insect capture apparatus of claim 1, wherein said bottom portion includes an attractant indicator.

6. An insect capture apparatus of claim 5, wherein said attractant indicator is a rise that protrudes from inside said bottom portion toward said top portion.

7. An insect capture apparatus of claim 1, wherein said internal barrier is removable from the apparatus.

8. An insect capture apparatus of claim 1, further including an insect attractant, wherein the insect attractant is in the form of a sachet that is designed and configured to rest between said internal barrier and said bottom portion.

9. An insect capture apparatus of claim 1, wherein said bottom portion, said top portion, and said internal barrier, when assembled together, permit viewing of the inside of the apparatus.

10. An insect capture system comprising:
a container including:
a top portion having an entry point extending toward a center of said container;
an internal barrier having a riser having an aperture and configured to cooperatively engage said entry point such that insects travel from said entry point through said aperture; and
a bottom portion coupled to said internal barrier and said top portion, said bottom portion designed and configured to receive an insect attractant.

11. A system according to claim 10, wherein said top portion and said bottom portion are releasably coupled to each other.

12. A system according to claim 10, wherein said riser has a plurality of slots sized and configured to allow insect to pass from the underside of said internal barrier to a region between said internal barrier and said top portion.

13. A system according to claim 10, wherein said bottom portion includes a rise that includes a mating connection suitable for attaching to an insect attractant.

14. A system according to claim 10, further including an attractant container for holding the insect attractant.

15. A system according to claim 14, wherein said attractant container is releasably coupled to said bottom portion.

16. A system according to claim 14, wherein said bottom portion includes a rise extending toward the center of said container and wherein said attractant container is releasably coupled to said rise.

17. A system of claim 14, wherein said bottom portion, said top portion, and said internal barrier, when assembled together, permit viewing of the inside of the apparatus.

18. A method of capturing insects comprising:
preparing an insect attractant;
luring the insects through an extended conically shaped aperture and into a capture device with the insect attractant;
preventing the escape of the insects by routing the insects away from the conically shaped aperture; and
trapping the insects in a region of the capture device that does not include direct access to the attractant.

19. A method according to claim 18, wherein said preventing is facilitated by an internal barrier with a plurality of slots leading form the underside of the internal barrier to the region.

20. The method according to claim 18, further including the step of releasing the trapped insects after said trapping.
